(19) United States
(12) Patent Application Publication
(10) Pub. No.: US 2016/0274435 A1
(43) Pub. Date: Sep. 22, 2016

(54) METHOD AND APPARATUS FOR HIGH RESOLUTION REFLECTIVE IMAGE DISPLAY

(71) Applicant: CLEARINK DISPLAYS, INC., Santa Clara, CA (US)

(72) Inventor: Lorne A. WHITEHEAD, Vancouver (CA)

(21) Appl. No.: 15/029,319

(22) PCT Filed: Oct. 23, 2014
(86) PCT No.: PCT/US14/61911

§ 371 Date: Apr. 14, 2016

Related U.S. Application Data
(60) Provisional application No. 61/894,771, filed on Oct. 23, 2013.

(51) Int. Cl. G02F 1/167; G02F 1/1335

(52) U.S. Cl. CPC G02F 1/167; G02F 1/1336; G02F 2001/1672; G02F 2001/133616

(57) ABSTRACT

A reflective image display comprising of a rigid and thermally stable layer is proposed where light is reflected in a semi-specular or semi-retro-reflective manner or absorbed by electrophoretically mobile particles. The layer is comprised of a plurality of cavities such as in the shape of hemispheres in hourglass-like shapes where the lateral displacement of the optical path of light entering and exiting the display is less than the width of a pixel leading to a high resolution reflective image display.

This application claims priority to Application No. PCT/US 14/61911, filed Oct. 23, 2014, under 35 U.S.C. §371 (U.S. National Stage) which claimed the filing date benefit of U.S. Provisional Application No. 61/894,771, filed on Oct. 23, 2013, the entirety of which is incorporated herein by reference.

### FIELD

The instant disclosure is directed to a method and apparatus for high resolution reflective image displays. Specifically, an embodiment of the disclosure relates to a high resolution reflective image display architecture having a plurality of micro-segregated structures.

### BACKGROUND

When light rays enter a reflective image display and are reflected, there is an average lateral displacement of the entering and exiting light rays. Depending on the angle of the incident light ray, the type of reflective surface and the total distance that the light ray travels, the degree of lateral displacement can vary greatly. The degree of lateral displacement can be problematic for two primary reasons if the lateral displacement leads to a light ray entering the display through one color pixel and exiting out another adjacent pixel of a different color, for example, in a reflective color display comprising of an RGB (red-green-blue) color filter array. A single pixel may be defined as the red, green or blue portion of an RGB color filter array. First, a loss of resolution results as the pixel edges are blurred. Second, a loss of efficiency results since the exiting light ray can end up having a lower intensity if, for example, it enters through a particular colored pixel and exits through a neighboring differently colored pixel.

The severity of these two effects depends on the degree of average lateral displacement. If lateral displacement is large, then the effects will be significant, and conversely, if the lateral displacement is small, then the effects will be insignificant. These effects are present both in monochrome and color displays. The loss of resolution may cause blurring. If, for example, the pixels are very small then even if there is some blurring present it may not affect the apparent resolution of the display as it is not observable by the naked eye. The loss of efficiency, though, is a potentially more serious problem. Even if the pixels are not visible to the naked eye, the efficiency loss has an averaging effect and will reduce the apparent contrast of the display.

While this is true both for monochrome and color image displays, it is a more challenging problem for color displays since the pixels are smaller and therefore the tolerance to lateral displacement is not nearly as high. In other words, it may be important to minimize the lateral displacement for a color display that has smaller pixels than for a monochrome display that typically has pixels that are about 3× larger. Thus, for example, in a color reflective image display it is preferred that in order to maintain a high quality color image the light that enters the display through a color pixel is reflected back to the viewer through the same color pixel. It may be essential that the sites within the reflective image display that reflects light are properly aligned or registered with the color pixels to be capable to create a high quality image. In order to be adequately aligned and to maintain the alignment, it is desirable to use components that are rigid and have substantial thermal stability.

Another desirable quality of reflective image displays comprising of light absorbing electrophoretically mobile particles suspended in an optically clear fluid is that the electrophoretically mobile particles are distributed with approximately equal density throughout the display such that the display appears substantially uniform in appearance during operation. It is also desirable that the appearance of the display maintains a high level of quality and efficiency throughout the life of the display.

### BRIEF DESCRIPTION OF DRAWINGS

These and other embodiments of the disclosure will be discussed with reference to the following exemplary and non-limiting illustrations, in which like elements are numbered similarly, and where:

FIG. 1 is a cross-sectional view of a portion of a display having hemispherical cavities;

FIG. 2 is a cross-sectional view of a portion of a front lit display having hemispherical cavities;

FIG. 3 is a cross-sectional view of a portion of a display with a front electrode disposed between the hemispherical cavities and a transparent outward sheet;

FIG. 4 is a cross-sectional view of a portion of a display having hemispherical cavities and a color filter array; and

FIG. 5 is a cross-sectional view of a display according to another embodiment of the disclosure.

### DETAILED DESCRIPTION

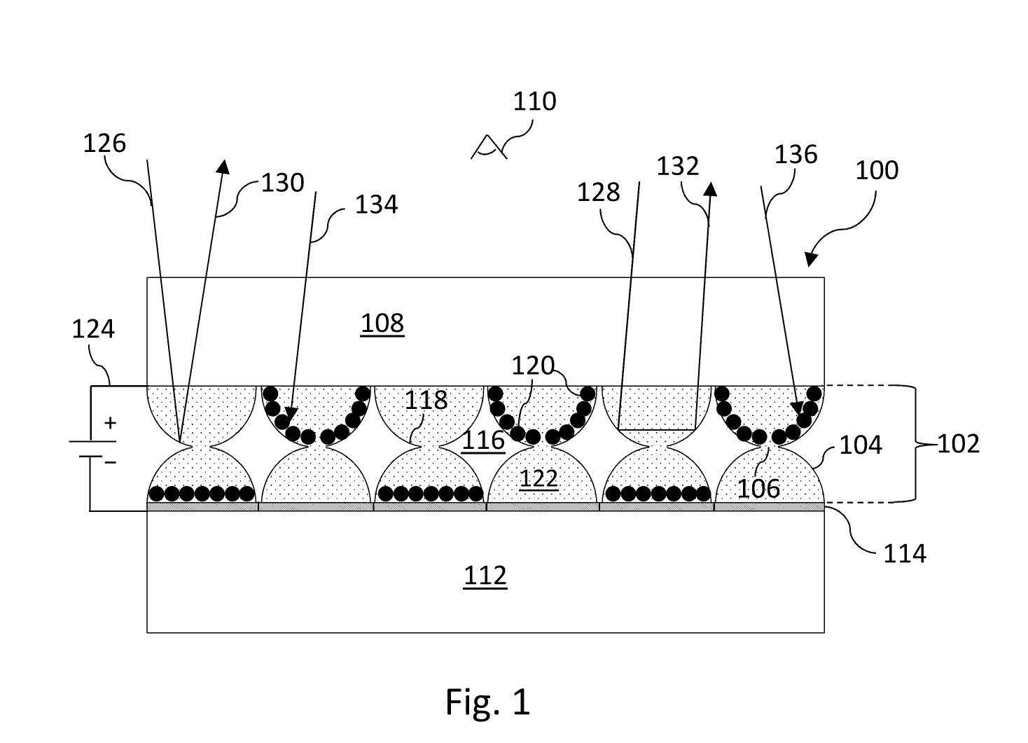

FIG. 1 is a cross-sectional view of a portion of a display having hemispherical cavities. Display 100 includes layer 102 having hemispherical cavities 104. Hemispherical cavities 104 (alternatively, chambers) are exemplary and may include any other shape, structure or permutation that behaves principally the same. Hemispherical cavities 104 have substantially an hourglass shape comprising a top cavity, a narrow opening (interchangeably, aperture) 106 and a bottom cavity.

Cavities 104 can be arranged in a variety of manners such as, but not limited to, hexagonal or square packed array. In one embodiment, the cavities are arranged in a hexagonal close packed array to best utilize the area within layer 102 and to also limit the amount of non-optically active zones in display 100. Display 100 also includes an outward transparent sheet 108 disposed between layer 102 and viewer 110, rear support 112 and rear electrode layer 114 disposed between rear support 112 and layer 102.

A number of methods that may be employed to connect or bond layer 102 to top transparent outward sheet 108 and the rear support 112 such as: chemical bonding, thermal bonding or pressure (press) bonding. The rear electrode 114 may be comprised of a thin film transistor (TFT), a direct drive patterned electrode array or a passive matrix grid electrode array and may be registered with the hemispherical cavities 104 such that, for example, each hemispherical cavity is aligned with a single transistor.

In one embodiment, layer 102 includes a plurality of hemispherical cavities 104 connected by a narrow opening 106 and may be composed of a rigid and thermally stable material. The material may be a transparent polymeric material such as polymethylmethacrylate also known as Plexiglas™. In another embodiment, the material may be comprised of glass.

A number of methods may be used to manufacture layer 102 with hemispherical cavities 104. For example, chemical etching may be used to create the cavities. Other methods may include machine etching and engraving, sand blasting and laser etching or embossing or stamping or molding. After etching layer 102, a minimal amount of material 116 may remain in place to impart rigidity, structural integrity and thermal stability to layer 102. FIG. 1 shows a thin wall of material between the widest regions of the adjacent hemispherical cavities 104. The walls are closest to the outward transparent sheet 108 and rear electrode 114. In one embodiment, the wall thickness is minimized to optimize the overall reflectance and contrast of the display. The walls further create a micro-segregated structure of hourglass-shaped voids.

It should be noted that the cavities in the embodiments described herein are not limited to hemispheres. Other shapes and designs may be envisioned that limit the lateral displacement of entering and exiting light rays to create a high resolution reflective display such as truncated cones or square pyramids. Hemispherical-shaped cavities are illustrated and described herein for conceptual purposes.

Display 100 of FIG. 1 further comprises a front electrode 118 positioned on a top surface of cavities 104 adjacent to the transparent outer sheet 108 and within layer 102. Electrode 118 may comprise a thin light reflective layer such as aluminum, silver, gold, aluminized Mylar™ flexible film or other conductive material to enhance reflectance. Also reflective layer 118 may be assembled by coating the surfaces of the top hemispherical cavities 104 with a reflective (e.g. aluminum, silver, gold) metallic film using conventional vapor deposition techniques. Within the hourglass-like voids of layer 102 contains electrophoretically mobile particles 120 suspended in an inert and optically clear fluid 122. Due to the micro-segregated structure and design of the display, micro-segregation confines the electrophoretically mobile particles 120 suspended in the fluid 122 preventing settling and migration of said particles 120 to maintain particle density that may lead to poor display performance over the life of the display.

Display 100 further comprises voltage source 124 that connects front electrode 118 and rear electrodes 114 such that an electromagnetic field may be applied across the medium containing electrophoretically mobile particles 120 suspended in the inert, optically transparent fluid 122. The voltage source may define an electromagnetic source or any source capable of delivering a required bias, voltage or current.

In one embodiment, rear electrode 114 includes a TFT or a patterned array registered (or integrated) with the rear or bottom hemispherical cavity 104 such that the electrophoretically mobile particles contained within each cavity be controlled separately to create high resolution images. In one embodiment, front electrode 118 may be coated over a portion of the hemispherical cavities. For example, the top portion of the hour glass maybe coupled to bias source 124 to act as the top electrode. Front electrode 118 may also be integrated with a portion of the hemispherical cavities 104. Alternatively, hemispherical cavities 104 may be partially or completely made of material suitable for internal reflection and/or redirection of light rays 126, 128. In an exemplary embodiment, light rays 126 and 128 may pass through transparent outer sheet 108 (internally reflected at front electrode surface 118) and be reflected outwardly as rays 130 and 132, respectively. The reflection may be in a semi-specular or semi-retro-reflective manner to create a light or reflective state of the respective pixels made up of single hemispherical cavities.

The reflection process may occur as bias (e.g., voltage) is applied such that mobile particles 120 are passed through narrow opening 106 within hourglass structures 104 and collect near rear electrode 114. Alternatively, the polarity of the applied bias may be reversed to move mobile particles 120 from rear electrode 114, through narrow opening 106, toward the surface of reflective front electrode 118. This enables light rays (e.g., 134 and 136) to be absorbed by mobile particles 120 within the individual hemispherical cavities 104 to thereby create a dark state.

To allow for ease of movement of the electrophoretically particles 120 through the narrow opening 106 of each hourglass-like structure within layer 102, opening 106 may be about 10× larger than the diameter of an electrophoretically mobile particles 120. It should be noted that all drawings in this application are conceptual in nature. For example, FIG. 1 depicts a monolayer of electrophoretically particles 120 assembled on the top surface of the top hemispherical cavity and at the rear electrode 114. This is not necessarily how the display actually operates, instead the particles may assemble as several layers of particles.

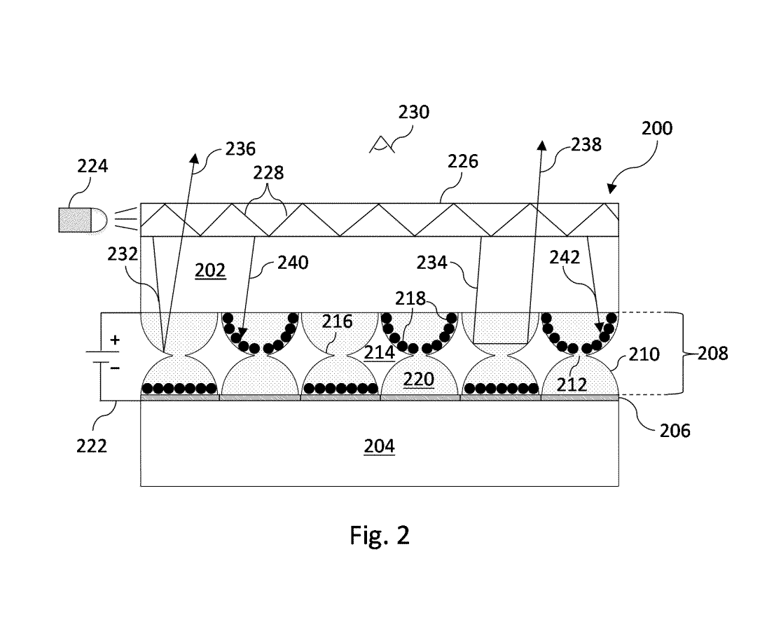

FIG. 2 is a cross-sectional view of a portion of a front lit display comprising of hemispherical cavities. Display 200 of FIG. 2 includes transparent outward sheet 202, rear support 204, rear electrode 206 comprising of a TFT or a direct drive patterned array or a passive matrix grid array of electrodes. Display 200 also includes layer 208 having a plurality of hemispherical cavities 210, each connected by narrow opening 212 in an hourglass-like shape. The hourglass-shaped cavities are disposed between transparent outward sheet 202 and rear electrode 206. Substrate 204 supports layer 208 for structural integrity. Reflective front electrode 216 may be located on a top surface of hemispherical cavities adjacent the transparent outward sheet 202. Electrophoretically mobile particles 218 may be suspended in an inert and an optically transparent fluid 220 contained within the hemispherical cavities and the apertures 212.

Display 200 may also include bias source (e.g., electromagnetic or voltage source) 222 which connects front electrode 216 and rear electrode 206 layers such that a bias may be applied therebetween. Display 200 shown may further comprises a directional front light source 224, light guide 226 and an array of light extractor elements 228. Light guide 226 may be positioned on a surface of transparent sheet 202 to directionally emit light in a perpendicular manner toward outward sheet 202. Front light source 224 may include a light emitting diode (LED), cold cathode fluorescent lamp (CCFL) or a surface mounted technology (SMT) incandescent lamp. Light guide 226 directs light to the entire surface of sheet 202 while light extractor elements 228 direct the incoming light rays in a substantially perpendicular direction within a narrow angle toward layer 208 of hemispherical cavities 210.

FIG. 2 also shows light rays 232 and 234 emitted in the perpendicular direction in a so-called non-Lambertian manner through transparent sheet 202 toward front electrode 216 where light rays (represented by light rays 236 and 238) are reflected back in a semi-specular or semi-retro-reflective manner toward viewer 230. This creates a light state in a manner that substantially preserves the non-Lambertian output of the front light source leading to a brighter display. The light state is enabled when mobile particles 218 are moved through narrow openings 212 toward rear electrode 206 where they collect near the rear electrode surface.

The polarity of an applied bias may be reversed to move mobile particles 218 from rear electrode 206, through the narrow opening 212, toward a surface of reflective front electrode 216. In this state the mobile particles absorb light rays 240 and 242 substantially within hemispherical cavities 210 to create a dark state. As with FIG. 1, the narrow opening 212 may be sized to about (or at least) 10 times larger than the diameter of an average mobile particle 218.

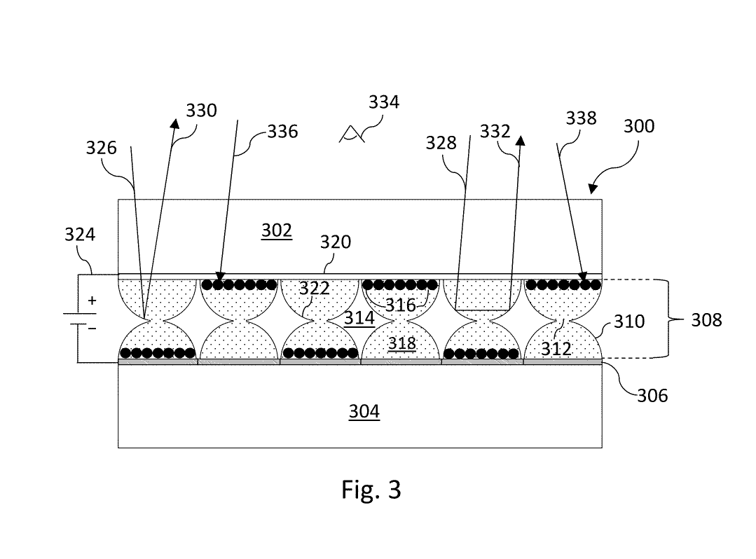

FIG. 3 is a schematic cross-sectional view of a portion of a display with a front electrode disposed between the hemispherical cavities and a transparent outward sheet. FIG. 3 may define an etched display. Display 300 of FIG. 3 may include transparent outward sheet 302, rear support 304, rear electrode 306 and layer 308. Layer 308 may include a plurality of top and bottom hemispherical cavities 310 connected by a narrow opening 312 to form an hourglass-like shape and disposed between the transparent outward sheet 302 and rear electrode layer 306. Display 300 also includes remaining solid material 314 after creating the hollow hemispherical cavities acting as a support within layer 308 for structural integrity. Electrophoretically mobile particles 316 may be suspended in an inert, optically transparent fluid 318 contained within the hemispherical cavities 310.

In FIG. 3, front electrode 320 is located on the underside of transparent outward sheet 302 and is disposed between the transparent outward sheet 302 and layer 308 of hemispherical cavities 310. In one embodiment, electrode layer 320 is comprised of a transparent conductive material such as indium tin oxide (no) or Baytron™ or conductive particles dispersed in a polymer matrix or combinations thereof. Display 300 may further comprise reflective layer 322 located on the surface of the top hemispherical cavities and may be composed of a light reflective metal layer such as aluminum, silver or gold. Reflective layer 322 may be assembled by coating the top surface of the hemispherical cavities 310 with a reflective metallic film using vapor deposition techniques. Display 300 may further comprise a bias source 324 connecting front electrode 320 and rear electrode 306 such that a bias may be applied therebetween.

FIG. 3 also shows incident light rays 326 and 328 passing through transparent outward sheet 302 and transparent front electrode layer 320 toward layer 308 where they are substantially reflected at surface 322 in a semi-specular or semi-retro-reflective manner (reflected light rays 330 and 332, respectively) back toward viewer 334. This creates the light state which is enabled when mobile particles 316 have been moved through narrow opening 312 toward the rear electrode 306. Alternatively, polarity of an applied bias may be reversed and electrophoretically mobile particles 316 may be moved through narrow opening 312 toward the surface of the transparent front electrode 320 and collect such that light rays (represented by light rays 336 and 338) are absorbed by mobile particles 316 within the individual hemispherical cavities 310. This creates a dark state.

Optionally, display 300 in FIG. 3 may further comprise a directional front light system as depicted in display 200 in FIG. 2. The front light system may comprise a front light source, light guide and light extractor elements to direct light in a non-Lambertian manner in the perpendicular direction toward layer 308. Light may be absorbed by the electrophoretically mobile particles 316 collected near the transparent front electrode surface 320 or reflected back to the viewer 334 by the reflective coating 322 on the surface of the top hemispherical cavities within layer 308 in a semi-specular or semi-retro-reflective manner to substantially preserve the non-Lambertian output of the front light system.

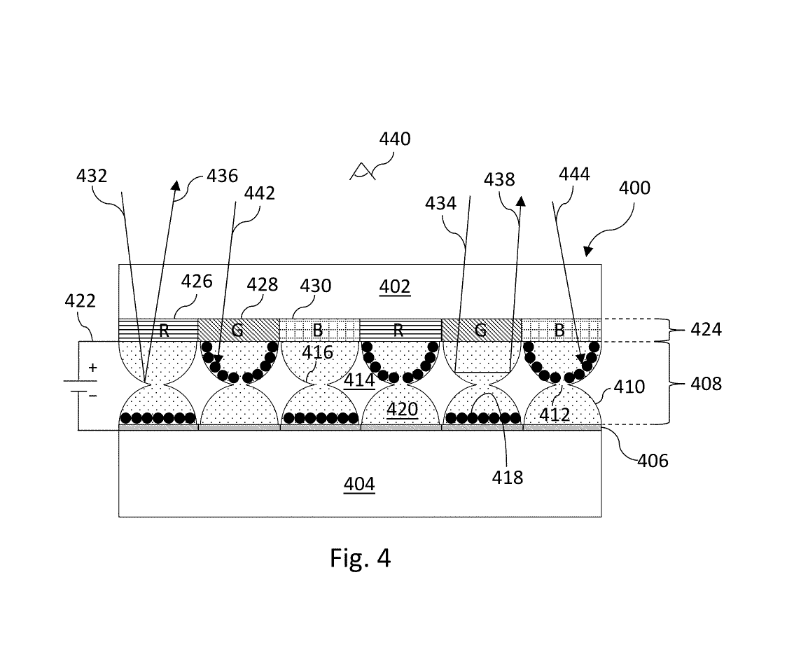

FIG. 4 is a cross-sectional view of a portion of a display comprising hemispherical cavities and a color filter array. Display 400 of FIG. 4 includes transparent outward sheet 402, rear support 404 and rear electrode 406. Rear electrode 406 includes a TFT or direct drive patterned array or a passive matrix grid array of electrodes. Layer 408 comprises a plurality of top and bottom hemispherical cavities 410 connected by a narrow opening 412 forming hourglass-like shapes. Layer 408 is disposed between transparent outward sheet 402 and rear electrode layer 406. Material 414 may be included to act as support of layer 408 for structural integrity. Reflective front electrode 416 may be formed on the surface of top hemispherical cavities adjacent the transparent outward sheet 402. Electrophoretically mobile particles 418 may be suspended in an inert, optically transparent, fluid 420 contained within hemispherical cavities 410.

Display 400 may further comprise voltage source 422 that connects front electrode 416 and rear electrode layers 406 such that bias may be applied across the medium comprising the electrophoretically mobile particles 418 suspended in the inert, optically clear fluid 420. Rear electrode 406 may include a TFT or direct drive patterned array or passive matrix grid array registered with each rear or bottom hemispherical cavity 410 such that particles 418 contained within each cavity may be controlled individually.

Display 400 may further comprise color filter layer 424 comprising of an array of individual pixels of colors such as red 426 (“R”), green 428 (“G”), and blue 430 (“B”). Alternatively the pixel colors may be cyan, magenta and yellow. In one embodiment each color pixel is registered with a single hemispherical cavity 410. To achieve a high resolution full color image with high efficiency, entering incident light rays and exiting reflected light rays pass through the same color pixel within the color filter array layer 424.

For example, incident light rays 432 and 434 pass through transparent outward sheet 402 and through color pixels red 426 and green 428, respectively. Light rays 432 and 434 are reflected at the reflective front electrode surface 416 in a semi-specular or semi-retro-reflective manner represented by reflected light rays 436 and 438, respectively, back through the same pixels of color filter layer 424 and transparent outward sheet 402 toward viewer 440 to create a light state when the electrophoretically mobile particles 418 have been moved through the narrow opening 412 toward the rear electrode 406 where they collect near the rear electrode surface. The polarity of an applied voltage may be reversed and the electrophoretically mobile particles 418 are moved from the rear electrode 406, through the narrow opening 412 and toward the surface of the transparent front electrode 416 where they collect near the surface. As a result, the incident light rays 442 and 444 are absorbed by the electrophoretically mobile particles 418 within the individual hemispherical cavities 410 to create a dark state.

Display 400 may optionally comprise a directional front light system as shown in FIG. 2. The front light system may comprise light source, light guide and light extractor elements to direct light in a non-Lambertian manner in the perpendicular direction toward layer 408. At layer 408 light may be absorbed by the electrophoretically mobile particles 418 (which may be collected near reflective front electrode surface 416) or it may be reflected back to viewer 440 by reflective coating 416 on the surface of top hemispherical cavities 410 in layer 408 in a semi-specular or semi-retro-reflective manner. The reflected light is reflected in such a way as to substantially preserve the non-Lambertian output of the front light system when the electrophoretically mobile particles 418 have been moved under the influence of an electric field to near the rear electrode surface 406.

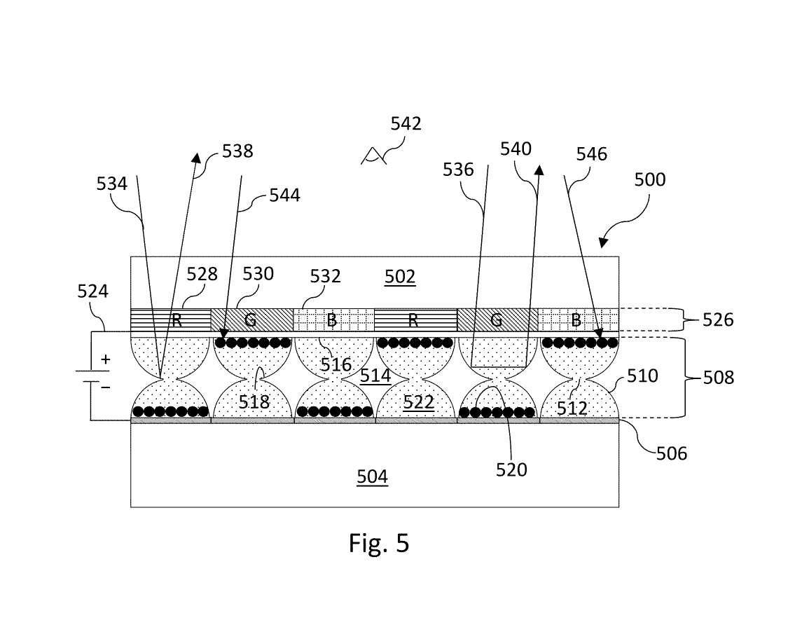

FIG. 5 is a cross-sectional view of a display according to another embodiment of the disclosure. In FIG. 5, the front electrode is disposed between the top hemispherical cavities and the transparent outward sheet and is equipped with a color filter array. Display 500 of FIG. 5 includes transparent outward sheet 502, rear support 504 and rear electrode 506. Rear electrode 506 may include a TFT or direct drive patterned array or passive matrix grid array. Layer 508 may comprise a plurality of top and bottom hemispherical cavities 510 connected by a narrow opening 512 forming an hourglass-like shape. The hour-glass shaped structures may be disposed between transparent outward sheet 502 and rear electrode layer 506. Material 514 exists to act as a support of the thin layer 508 for structural integrity.

In FIG. 5, front electrode 516 is located on the underside of the color filter layer 526 and is disposed between the color filter layer 526 and the thin layer 508 of etched top hemispherical cavities 510 as depicted in FIG. 5. Optionally in another embodiment, the transparent front electrode 516 may also be located on the underside of the transparent outward sheet 502, between transparent outward sheet 502 and color filter layer 526.

Electrode layer 516 may include a transparent conductive material such as indium tin oxide (no) or Baytron™ or conductive particles dispersed in a polymer matrix or a combination thereof. Display 500 may further comprise reflective layer 518 located on a surface of top hemispherical cavities. The reflective layer 518 may comprise a light reflective metal layer such as aluminum, silver, gold or other similar material. Reflective layer 518 may be assembled by coating the top surface of hemispherical cavities 510 with a reflective (e.g. aluminum, silver, gold) metallic film using, for example, vapor deposition techniques.

Display 500 further comprises electrophoretically mobile particles 520 suspended in an inert, optically transparent fluid 522. The transparent fluid and mobile particles may be contained within hemispherical cavities. Bias (e.g., voltage) source 524 connects front electrode 516 and rear electrode layers 506 such that an electromagnetic bias may be applied across the medium comprising the electrophoretically mobile particles 520 suspended in fluid 522.

The display may further comprise color filter layer 526 comprising an array of individual pixels of colors such as red 528 (“R”), green 530 (“G”) and blue 532 (“B”). Alternatively, the pixel colors may be cyan, magenta and yellow or any other suitable color. Each color pixel may be registered with a single hemispherical cavity 510 as shown in FIG. 5. To achieve a high resolution full color image, it may be necessary for the total optical path followed by a light ray as it travels through the display to be less than the width of an individual color pixel within the color filter array layer 526. In other words, when light enters a display through one pixel and is reflected back towards the viewer the exiting light ray exits through the same color pixel that initially entered the display. This significantly increases the resolution of the display. Conversely, low resolution display occurs when a light ray enters the display through one color pixel and is reflected in a manner such that it exits through an adjacent (differently colored) pixel.

In FIG. 5, for example, incident light rays 534 and 536 pass through transparent outward sheet 502, transparent front electrode 516 and color pixels red 528 and green 530, respectively. Light rays, 534 and 536 are reflected at the reflective front electrode surface 518 in a semi-specular or semi-retro-reflective manner as shown by reflected rays 538 and 540, respectively. Reflected light rays traverse through transparent front electrode 516, color filter layer 526 and transparent outward sheet 502 toward viewer 542 to create a light state. In the light state the electrophoretically mobile particles 520 are been moved through narrow openings 512 toward rear electrode 506 where they collect near the rear electrode surface.

The polarity of the applied bias may be reversed and the electrophoretically mobile particles 520 are then moved from rear electrode 506 toward the surface of the transparent front electrode 516. The particles collect such that incident light rays 544 and 546 are absorbed by particles 520 within the individual hemispherical cavities 510. This creates a dark state.

Display 500 in FIG. 5 may further comprise a directional front light system as depicted in FIG. 2. The front light system may comprise a front light source, light guide and light extractor elements. The front light system thus directs light in a non-Lambertian manner in the perpendicular direction through the color filter layer 526 and transparent front electrode layer 516 where light may be absorbed by the electrophoretically mobile particles 520 collected near the transparent front electrode surface 516 under an applied voltage. The light rays may be reflected at the reflective surface 518 located on the top hemispherical cavities 510 within layer 508 back toward the viewer 542 in a semi-specular or semi-retro-reflective manner. This substantially preserves the non-Lambertian output of the front light system when the electrophoretically mobile particles 520 have been moved under the influence of an electric field to the rear electrode surface 506.

The disclosed embodiments may be used in such applications as electronic book readers, portable computers, tablet computers, cellular telephones, smart cards, signs, watches, wearables, shelf labels, flash drives and outdoor billboards or outdoor signs comprising a display.

The following exemplary and non-limiting embodiments provide various implementations of the disclosure. Example 1 is directed to an image display device, comprising: an outward transparent sheet; a rear support; an aperture positioned between the outward transparent sheet and the rear support, the aperture separating an upper chamber and a lower chamber; a plurality of electrophoretically mobile particles to dynamically move through the aperture between the upper and the lower chambers; and an electromagnetic source to bias movement of the plurality of electrophoretically mobile particles through the aperture between the upper and the lower chambers.

Example 2 is directed to the image display device of example 1, further comprising an optically transparent fluid to at least partially fill a space between the upper and the lower chambers.

Example 3 is directed to the image display device of example 2, wherein the optically transparent fluid communicates the plurality of electrophoretically mobile particles through the aperture and between the upper and the lower chambers.

Example 4 is directed to the image display device of example 1, further comprising a rear electrode adjacent the rear support.

Example 5 is directed to the image display device of example 1, wherein the electromagnetic source is configured to selectively move electrophoretically mobile particles through the aperture and between the upper and lower chambers.

Example 6 is directed to the image display device of example 1, further comprising a front electrode positioned adjacent to at least a portion of the upper chamber.

Example 7 is directed to the image display device of example 6, wherein the front electrode defines a light reflective material.

Example 8 is directed to the image display device of example 1, wherein the electromagnetic source is configured to cause a first bias between the front electrode and the rear electrode, the first bias to move the electrophoretically mobile particles toward the rear electrode to thereby allow light rays to be reflected by the upper chamber.

Example 9 is directed to the image display device of example 1, wherein the electromagnetic source is further configured to cause a second bias between the front electrode and the rear electrode, the second bias to move the electrophoretically mobile particles toward the front electrode to thereby absorb substantially all incident rays passing through the transparent outward sheet.

Example 10 is directed to the image display device of example 1, wherein the upper chamber is configured to limit lateral displacement of an incident or reflected light rays to a distance about less than the width of a pixel.

Example 11 is directed to an image display device, comprising: an outward transparent sheet; a rear support; a first layer to limit lateral displacement of a reflected incident light ray to distances less than the width of a pixel such that the incident and reflected light rays pass through the same pixel; a plurality of electrophoretically mobile particles to dynamically move within the first layer; and an electromagnetic source to bias movement of the plurality of electrophoretically mobile particles through the first layer.

Example 12 is directed to the image display device of example 11, wherein the first layer further comprises an upper chamber and a lower chamber separated by an aperture.

Example 13 is directed to the image display device of example 12, further comprising an optically transparent fluid to at least partially fill a space between the upper and the lower chambers and to communicate the plurality of electrophoretically mobile particles between the upper and the lower chambers.

Example 14 is directed to the image display device of example 11, further comprising a rear electrode adjacent the rear support.

Example 15 is directed to the image display device of example 11, wherein the electromagnetic source is configured to selectively move electrophoretically mobile particles to be proximal to one of the outward transparent sheet or the rear support.

Example 16 is directed to the image display device of example 11, further comprising a front electrode positioned proximal to the outward transparent sheet.

Example 17 is directed to the image display device of example 16, wherein the front electrode defines a light reflective material.

Example 18 is directed to the image display device of example 16, wherein the electromagnetic source is configured to cause a first bias between the front electrode and the rear electrode, the first bias to move the electrophoretically mobile particles toward the rear electrode to thereby allow light rays to be reflected by the upper chamber.

Example 19 is directed to the image display device of example 16, wherein the electromagnetic source is further configured to cause a second bias between the front electrode and the rear electrode, the second bias to move the electrophoretically mobile particles toward the front electrode to thereby absorb substantially all incident rays passing through the transparent outward sheet.

Example 20 is directed to a method to switch from a dark state to a light state at a pixel, the method comprising: biasing a top electrode at a top chamber relative to a rear electrode at a bottom chamber at a first charge to form an electromagnetic field in the bottom chamber to substantially attract a plurality of electrophoretically charged particles to the bottom chamber such that light is reflected at the top surface adjacent the top chamber.

Example 21 is directed to the method of example 20, further comprising biasing the top electrode relative to the rear electrode to communicate at least one of the plurality of electrophoretically charged particles through an aperture connecting the top chamber to the bottom chamber.

Example 22 is directed to the method of example 20, further comprising receiving an incoming ray at a pixel and substantially reflecting the incoming ray from the pixel.

Example 23 is directed to a method to switch from a light state to a dark state at a pixel, the method comprising: biasing a top electrode relative to a rear electrode to form an electromagnetic field to attract a plurality of suspended electrophoretically charged particles to a top chamber region from a bottom chamber region to thereby absorb an incoming light ray.

Example 24 is directed to the method of example 23, further comprising biasing the top electrode relative to the rear electrode to communicate at least one of the plurality of suspended electrophoretically charged particles through an aperture connecting the top chamber to the bottom chamber.

Example 25 is directed to the method of example 23, further comprising receiving an incoming ray at a pixel and substantially reflecting the incoming ray from the same pixel.

While the principles of the disclosure have been illustrated in relation to the exemplary embodiments shown herein, the principles of the disclosure are not limited thereto and include any modification, variation or permutation thereof.

What is claimed is:

1. An image display device, comprising:
an outward transparent sheet;
a rear support;
an aperture positioned between the outward transparent sheet and the rear support, the aperture separating an upper chamber and a lower chamber;
a plurality of electrophoretically mobile particles to dynamically move through the aperture between the upper and the lower chambers; and
an electromagnetic source to bias movement of the plurality of electrophoretically mobile particles through the aperture between the upper and the lower chambers.

2. The image display device of claim 1, further comprising an optically transparent fluid to at least partially fill a space between the upper and the lower chambers.

3. The image display device of claim 2, wherein the optically transparent fluid communicates the plurality of electrophoretically mobile particles through the aperture and between the upper and the lower chambers.

4. The image display device of claim 1, further comprising a rear electrode adjacent the rear support.

5. The image display device of claim 1, wherein the electromagnetic source is configured to selectively move electrophoretically mobile particles through the aperture and between the upper and lower chambers.

6. The image display device of claim 1, further comprising a front electrode positioned adjacent to at least a portion of the upper chamber.

7. The image display device of claim 6, wherein the front electrode defines a light reflective material.

8. The image display device of claim 1, wherein the electromagnetic source is configured to cause a first bias between the front electrode and the rear electrode, the first bias to move the electrophoretically mobile particles toward the rear electrode to thereby allow light rays to be reflected by the upper chamber.

9. The image display device of claim 1, wherein the electromagnetic source is further configured to cause a second bias between the front electrode and the rear electrode, the second bias to move the electrophoretically mobile particles toward the front electrode to thereby absorb substantially all incident rays passing through the transparent outward sheet.

10. The image display device of claim 1, wherein the upper chamber is configured to limit lateral displacement of an incident or reflected light rays to a distance about less than the width of a pixel.

11. An image display device, comprising:
an outward transparent sheet;
a rear support;
a first layer to limit lateral displacement of a reflected incident light ray to distances less than the width of a pixel such that the incident and reflected light rays pass through the same pixel;
a plurality of electrophoretically mobile particles to dynamically move within the first layer; and
an electromagnetic source to bias movement of the plurality of electrophoretically mobile particles through the first layer.

12. The image display device of claim 11, wherein the first layer further comprises an upper chamber and a lower chamber separated by an aperture.

13. The image display device of claim 12, further comprising an optically transparent fluid to at least partially fill a space between the upper and the lower chambers and to communicate the plurality of electrophoretically mobile particles between the upper and the lower chambers.

14. The image display device of claim 11, further comprising a rear electrode adjacent the rear support.

15. The image display device of claim 11, wherein the electromagnetic source is configured to selectively move electrophoretically mobile particles to be proximal to one of the outward transparent sheet or the rear support.

16. The image display device of claim 11, further comprising a front electrode positioned proximal to the outward transparent sheet.

17. The image display device of claim 16, wherein the front electrode defines a light reflective material.

18. The image display device of claim 16, wherein the electromagnetic source is configured to cause a first bias between the front electrode and the rear electrode, the first bias to move the electrophoretically mobile particles toward the rear electrode to thereby allow light rays to be reflected by the upper chamber.

19. The image display device of claim 16, wherein the electromagnetic source is further configured to cause a second bias between the front electrode and the rear electrode, the second bias to move the electrophoretically mobile particles toward the front electrode to thereby absorb substantially all incident rays passing through the transparent outward sheet.

20. A method to switch from a dark state to a light state at a pixel, the method comprising: biasing a top electrode at a top chamber relative to a rear electrode at a bottom chamber at a first charge to form an electromagnetic field in the bottom chamber to substantially attract a plurality of electrophoretically charged particles to the bottom chamber such that light is reflected at the top surface adjacent the top chamber.

21. The method of claim 20, further comprising biasing the top electrode relative to the rear electrode to communicate at least one of the plurality of electrophoretically charged particles through an aperture connecting the top chamber to the bottom chamber.

22. The method of claim 20, further comprising receiving an incoming ray at a pixel and substantially reflecting the incoming ray from the pixel.

23. A method to switch from a light state to a dark state at a pixel, the method comprising: biasing a top electrode relative to a rear electrode to form an electromagnetic field to attract a plurality of suspended electrophoretically charged particles to a top chamber region from a bottom chamber region to thereby absorb an incoming light ray.

24. The method of claim 23, further comprising biasing the top electrode relative to the rear electrode to communicate at least one of the plurality of suspended electrophoretically charged particles through an aperture connecting the top chamber to the bottom chamber.

25. The method of claim 23, further comprising receiving an incoming ray at a pixel and substantially reflecting the incoming ray from the pixel.
